(19) United States
(12) Patent Application Publication
(10) Pub. No.: US 2008/0180610 A1
(43) Pub. Date: Jul. 31, 2008

(54) LIQUID CRYSTAL DISPLAY PANEL AND METHOD OF MANUFACTURING THE SAME

(75) Inventor: Takeshi OHASHI, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/956,907

(22) Filed: Dec. 14, 2007

(30) Foreign Application Priority Data
Jan. 25, 2007 (JP) 2007-014739

(51) Int. Cl. G02F 1/1335

(52) U.S. Cl. 349/106; 349/187

(57) ABSTRACT

A liquid crystal display panel includes a first substrate comprising a first transparent insulating substrate, a second substrate comprising a second transparent insulating substrate disposed to oppose the first transparent insulating substrate, a light-shielding layer and a coloring layer formed to a side of the first transparent insulating substrate over the second transparent insulating substrate. For the first substrate, at least a part of an insulating film of a terminal area adjacent to a liquid crystal inlet portion of a seal material of another liquid crystal display panel is removed, which has been adjacent to the liquid crystal panel before cutting.

### BACKGROUND OF THE INVENTION

1. Field of the Invention

The present invention relates to a liquid crystal display panel and a method of manufacturing the same manufactured using a large-sized substrate.

2. Description of Related Art

A liquid crystal display is formed of a lower transparent insulating substrate (TFT substrate) stacked with a thin film transistor and an alignment layer etc. and an upper transparent insulating substrate (color filter substrate) stacked with a color filter and an alignment layer etc. overlapped with a predetermined gap between them using an in-plane spacer and peripheral portions are adhered with a seal material. Moreover, the liquid crystal display includes a liquid crystal display panel formed by injecting a liquid crystal from a liquid crystal inlet formed to a part of the seal material, sealing it and bonding a polarizing plate to outside of both substrates and a backlight disposed to one of the substrate side.

The TFT substrate is formed by forming and patterning various electrodes, an insulating film and a semiconductor layer to a transparent insulating substrate (glass substrate). The color filter substrate is formed by forming, applying and patterning a light-shielding film, a coloring layer and a transparent conductive film to a transparent insulating substrate (glass substrate).

When forming a plurality of liquid crystal display panels to a transparent insulating substrate, if the gap between liquid crystal display panels is made as narrow as possible, the number of liquid crystal display panels for each transparent insulating substrate will increase. By the increase in the number of panels produced from a single substrate, productivity improves. Moreover, when producing multiple panels from one substrate, the substrate can be effectively used by closely contacting panels.

Japanese Unexamined Patent Application Publication No. 2002-98942 (Shinohara) discloses a manufacturing method of a liquid crystal cell aiming to manufacture a liquid crystal cell which does not cause to reduce yield and work efficiency and also leaves only a slight amount of seal material in the terminal arranged portion. That is, a pair of large-sized substrates having electrodes etc. formed to a plurality of regions to be each unit of a liquid crystal cell are prepared. Then, the pair of large-sized substrates are bonded together with a frame shaped seal material provided in each of the regions, these large-sized substrates are scribed along with a predetermined line to be separated into each region so as to manufacture a plurality of liquid crystal cells. At this time, while forming a pair of projecting walls for forming a liquid crystal inlet which projects from the inner side toward outside a region in the middle of the seal material, the tip part of these projecting walls is made into a narrow portion whose width is narrower than the width of the base of the projecting walls, and the narrow portion is projected from one region to another adjacent region, then the narrow portion is cut in a process to scribe between the regions.

By the way, removing the gap between liquid crystal display panels (gap 0) improves productivity. With gap 0, as shown in FIG. 9, when forming an inlet portion 105 to a side 90 degrees different from a region where a terminal 108 is formed to a side of a color filter (CF) outline 103 of a target panel 110, the dimension from a seal material (seal pattern) 104 of a panel 110a adjacent to the target panel 110 to a TFT panel outline 102 must be made large. When overlapping a TFT substrate and a CF substrate to apply a thermal compression bonding, gas contained between the TFT substrate and the CF substrate must be discharged outside the substrates, thus it is necessary to secure a path for the gas from the inlet portion 105 to the substrate edge. Therefore, the inlet portion 105 and the seal material 104 of the adjacent panel 110a must be separated.

Accordingly, as shown in FIG. 1, an inlet portion 5 is formed to the counter-terminal side, which is opposite side of a terminal 8. In this case, the terminal 8 is disposed between the inlet portion 5 in a target panel 100 to a seal material 4 of an adjacent panel 100a. Thus it is unnecessary to leave a distance in the target panel 100 to the seal material of the adjacent panel 100a. In order to minimize the size of a TFT panel outline 2 having the inlet portion 5, it is necessary to form the inlet portion 5 to the counter-terminal side, which is the opposite side of the terminal area and form the projecting portion (protrusion) of the seal material to the adjacent panel 100a in the inlet portion 5. As shown in FIG. 1, when forming the inlet portion 5 to the counter-terminal side in the target panel 100, a part of the seal material 4 of the inlet portion 5 runs on the terminal area of the adjacent panel 100a.

In the abovementioned manufacturing method of a liquid crystal cell disclosed by Shinohara, the seal material in the cut section is made as thin as possible to make the area running on the terminal area be as small as possible. However when making the seal material of the panel projecting portion thin, it is necessary to secure a seal width required for the inlet portion in consideration of having a displacement of the seal material. Therefore, there is a limit also in making the seal material of the panel projecting portion thin.

The present invention seeks to solve one or more of the above problems, or to improve upon those problems at least in part and aims to reduce the seal material area of the inlet portion running on the terminal area when disposing panels closely so as to facilitate to cut and to minimize the terminal region.

### SUMMARY OF THE INVENTION

According to an aspect of the present invention, there is provided a liquid crystal display panel that includes a first substrate comprising a first transparent insulating substrate, a plurality of scanning lines formed over the first transparent insulating substrate, a plurality of signal lines disposed in matrix to cross the scanning lines, a first insulating film for electrically insulating the scanning lines and the signal lines, a second insulating film for covering and protecting the signal lines, a switching device provided to correspond with each crossing part of the plurality of scanning lines and the plurality of signal lines and a pixel electrode electrically connected with the switching device, a second substrate comprising a second transparent insulating substrate disposed to oppose the first transparent insulating substrate, a light-shielding layer and a coloring layer formed to a side of the first transparent insulating substrate over the second transparent insulating substrate and a seal material provided between the first substrate and the second substrate and also in a peripheral portion of a display region. At least a part of the first insulating film or the second insulating film of a terminal area adjacent to a liquid crystal inlet portion of the seal material of another liquid crystal display panel is removed, where the another liquid crystal display panel has been adjacent to the liquid crystal panel before cutting.

According to another aspect of the present invention, there is provided a liquid crystal display panel that includes a first substrate comprising a first transparent insulating substrate, a plurality of scanning lines formed of a metal layer formed over the first transparent insulating substrate, a plurality of signal lines disposed in matrix to cross the scanning lines, a first insulating film for electrically insulating the scanning lines and the signal lines, a second insulating film for covering and protecting the signal line, a switching device provided to correspond with each crossing part of the plurality of scanning lines and the plurality of signal lines and a pixel electrode electrically connected with the switching device, a second substrate comprising a second transparent insulating substrate disposed to oppose the first transparent insulating substrate, a light-shielding layer and a coloring layer formed to a side of the first transparent insulating substrate over the second transparent insulating substrate and a seal material provided between the first substrate and the second substrate and also in a peripheral portion of a display region. A part of the light-shielding layer in a liquid crystal inlet portion is removed for the second substrate.

According to another aspect of the present invention, there is provided a method of manufacturing a liquid crystal panel that includes forming a switching device over a first transparent insulating substrate, forming a first insulating film for electrically insulating a scanning line and a signal line and a second insulating film for covering and protecting the signal line over the switching device, forming a pixel electrode provided to correspond with each crossing part of a plurality of the scanning lines and a plurality of the signal lines over the second insulating film and removing at least a part of the first insulating film or the second insulating film in a terminal area adjacent to a liquid crystal inlet portion of another liquid crystal display panel, where the another liquid crystal panel has been adjacent to the liquid crystal panel before cutting substrates.

According to another aspect of the present invention, there is provided a method of manufacturing a liquid crystal display panel that includes forming a switching device over a first transparent insulating substrate, forming a first insulating film for electrically insulating a scanning line and a signal line and a second insulating film for covering and protecting the signal line over the switching device, forming a light-shielding layer and a coloring layer over a second transparent insulating substrate disposed to oppose the first transparent insulating substrate, removing a part of the light-shielding layer over the second transparent insulating substrate in a liquid crystal inlet portion to form a second substrate and bonding the first substrate and the second substrate with a seal material therebetween.

The present invention is able to provide a display device which enables to make the seal material area of the inlet portion running over the terminal area as small as possible so as to facilitate cutting and also to minimize the terminal area and a method of manufacturing the same.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a pattern diagram showing a plurality of liquid crystal display panels formed over a substrate;

FIG. 2A is a plan view showing a liquid crystal display panel formed by cutting the bonded substrate shown in FIG. 1;

FIG. 2B is a cross-sectional diagram taken along the line IIB-IIB;

FIGS. 3A and 3B are a schematic cross-sectional diagram of a liquid crystal display panel according to an embodiment of the present invention and the configuration of a liquid crystal inlet portion viewed from the top surface;

FIG. 4 is a flowchart showing an assembling process of a liquid crystal display panel;

FIG. 5 shows a liquid crystal display panel according to a first modification of an embodiment of the invention;

FIG. 6 shows a liquid crystal display panel according to a second modification of the embodiment of the invention;

FIGS. 7A and 7B show a liquid crystal display panel and a plan view of an inlet portion according to a third modification of the embodiment of the present invention;

FIGS. 8A and 8B show a liquid crystal display panel and a plan view of an inlet portion according to a fourth modification of the embodiment of the present invention;

FIG. 9 is a pattern diagram showing a plurality of liquid crystal display panels formed over a substrate according to a related art; and

FIGS. 10A and 10B are schematic cross-sectional diagram of a liquid crystal panel and the configuration of a liquid crystal inlet portion according to a related art.

### DESCRIPTION OF THE PREFERRED EMBODIMENTS

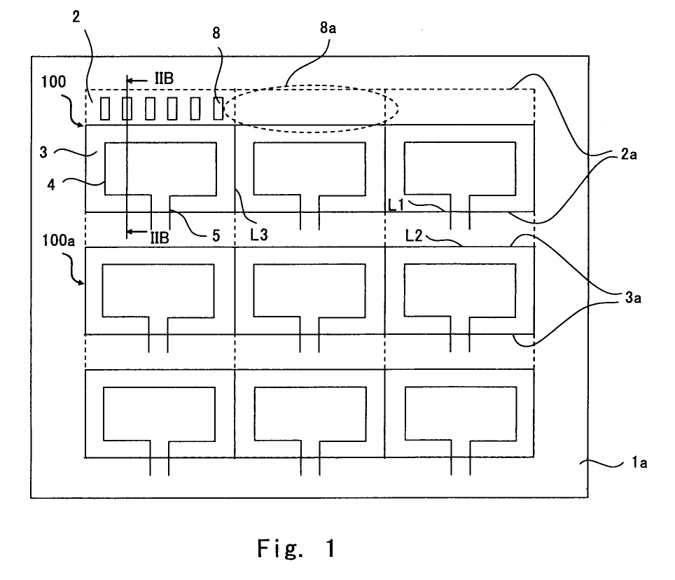

Hereafter, a detailed embodiment incorporating the present invention is described with reference to the drawings. FIG. 1 is a pattern diagram showing a plurality of liquid crystal display panels formed over a substrate. As shown in FIG. 1, a transparent insulating substrate (not shown) for forming a CF panel 3 is disposed with a seal material 4 between to a transparent insulating substrate 1a for forming a TFT panel 2. As for the seal material 4, the inlet portion 5 is formed to the counter-terminal side where the terminal 8 is not formed. 3a indicates a CF panel outline after cutting and 2a indicates a TFT panel outline after cutting. Moreover, suppose that 100 is a target liquid crystal panel, 100a indicates an adjacent liquid crystal panel. By cutting along a scribe line L1 formed over the substrate, a liquid crystal can be injected and by cutting along lines L2 and L3, the liquid crystal display panel 100 can be manufactured.

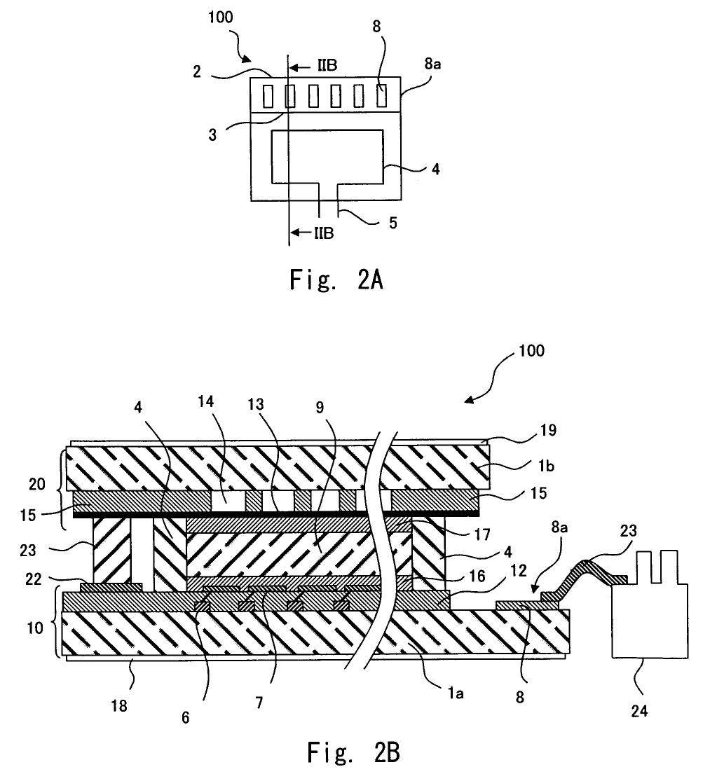

FIG. 2A is a plan view showing the liquid crystal display panel 100 formed by cutting the bonded substrate shown in FIG. 1. FIG. 2B is a cross-sectional diagram taken along the line IIB-IIB. In this embodiment, a TFT liquid crystal display panel is explained as an example of the configuration of a liquid crystal display panel. As shown in FIG. 2B, this liquid crystal display panel 100 includes a switching device substrate 10, a color filter substrate 20 and a liquid crystal 9 filled between the switching device substrate 10 and the color filter substrate 20.

The switching device substrate 10 includes an alignment layer 16 for aligning the liquid crystal 9 to one surface of a transparent insulating substrate 1a, a pixel electrode 7 provided to the lower part of the alignment layer 16 for applying a voltage to drive the liquid crystal 9, a switching device 6 such as TFT for supplying a voltage to the pixel electrode 7, an insulating film 12 for covering the switching device 6, a terminal 8 for receiving a signal supplied to the switching device 6 from outside and a transfer electrode 22 for transmitting the signal input from the terminal 8 to an opposing electrode (common electrode) 13 or the like. Moreover, a polarizing plate 18 is formed to the other side of the transparent insulating substrate 1a. However, in this embodiment, the insulating film 12 of the terminal 8 side of the switching device substrate 10 is not included. The details of this configuration are mentioned later.

On the other hand, the abovementioned color filter substrate 20 includes an alignment layer 17 for aligning the liquid crystal 9 to one surface of a transparent insulating substrate 1b, a common electrode 13 disposed to the lower part of the alignment layer 17 for generating an electric field between the pixel electrode 7 over the switching device substrate 10 to drive the liquid crystal 9, a color filter 14 provided to the lower part of the common electrode 13 and a light-shielding layer (black matrix) 15 or the like. Moreover, a polarizing plate 19 is formed to the other side of the transparent insulating substrate 1b. Note that the common electrode may be formed to the switching device substrate 10 side.

Moreover, the switching device substrate 10 and the color filter substrate 20 are bonded with the seal material between them. Furthermore, the transfer electrode 22 and the common electrode 13 are electrically connected by the transfer material 23. A signal input from the terminal 8 is transmitted to the common electrode 13. Other than this, the liquid crystal display panel 100 includes a control substrate 24 for generating a driving signal, a FFC (Flexible Flat Cable) 23 for electrically connecting the control substrate 24 to the terminal 8 and a backlight unit (not shown) used as a luminous source, etc.

This liquid crystal display panel 100 operates as follows. For example, if an electric signal is input from the control substrate 24, a drive voltage is applied to the pixel electrode 7 and the common electrode 13, and the direction of the molecule of the liquid crystal 9 changes according to the drive voltage. Then, by the light emitted by the backlight unit passing through outside or being blocked via the switching device 10, the liquid crystal 9 and the color filter 20, an image or the like is displayed on the liquid crystal display panel 100.

Note that this liquid crystal display panel 100 is an example and may be other configurations. The operation mode of the liquid crystal panel 100 may be TN (Twisted Nematic) mode, STN (Supper Twisted Nematic) mode and ferroelectric liquid crystal mode, etc. Moreover, the driving method may be a simple matrix or an active matrix, etc. Furthermore, it may be a liquid crystal display panel using transverse electric field system in which the common electrode 13 provided to the color filter substrate 20 is provided to the switching device substrate side so as to apply an electric field to the liquid crystal 9 in transverse direction between the pixel electrode 7 and the common electrode 13.

Here, the liquid crystal display panel according to this embodiment reduces the area of the seal material (seal pattern) of the inlet portion 5 running on the terminal area 8a when disposing liquid crystal display panels closely and aims to facilitate cutting and minimize the area of the terminal area 8a. Then, in this embodiment, by reducing the thickness of the panel edge of the terminal area 8a which contacts the inlet portion 5, the projecting amount of the seal is reduced.

In addition, as a switching device substrate, the arrangement of the insulating film may vary for example in a case TFT is a top gate or bottom gate type, in a case pixel electrode is top layer or in other lower layer. However, whatever the arrangement is for the insulating film, by removing a part or all of the insulting film of the terminal 8 side, the projecting amount of the seal can be reduced. Moreover, as the configuration of the insulating film differs by the difference in the configuration of a switching device, detailed configuration of the insulating film 12 is omitted in FIGS. 2A and 2B and the insulating film 12 over the switching device substrate 10 is explained as one layer. However the insulating film 12 is formed of 2 kinds of insulating films, which are a first insulating film with a function to electrically insulate between scanning and signal lines and a second insulating film formed to cover over the signal line to protect. Then, these 2 kinds of insulating films are formed by single or multiple insulating films, and by removing at least a part of these insulating films, the projecting amount of the seal can be reduced.

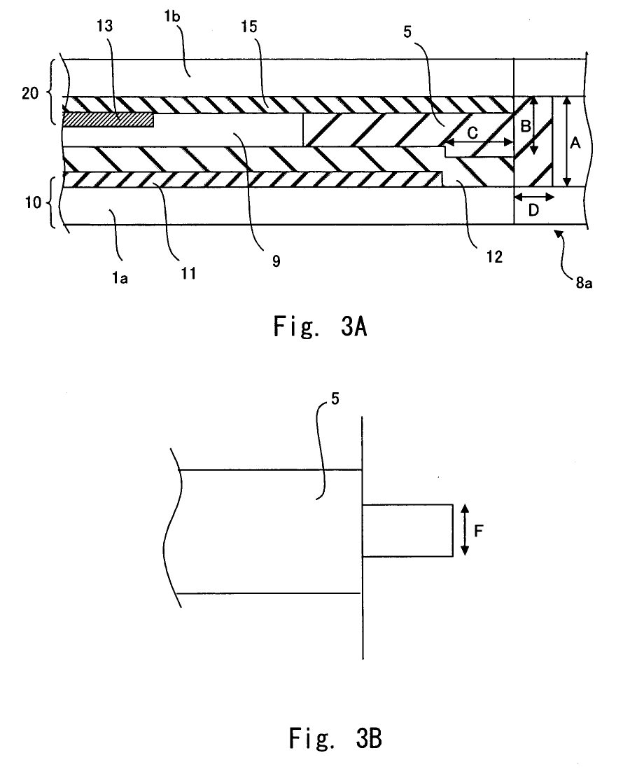

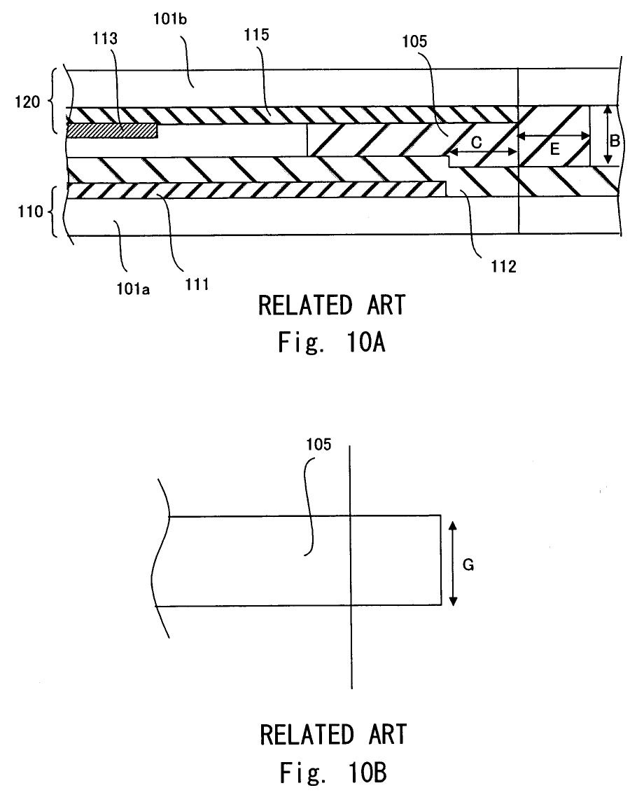

FIGS. 3A and 3B are schematic cross-sectional diagram of the liquid crystal panel and the configuration of a liquid crystal inlet viewed from the top surface according to this embodiment. Moreover, FIGS. 10A and 10B are schematic cross-sectional diagram of a liquid crystal panel and a top view of a liquid crystal inlet portion according to a related art. In FIGS. 3A, 3B, 10A and 10B, A is a gap between the switching device substrate 10 and the color filter substrate 20 and is a gap of the seal portion in this embodiment. B is a gap from the insulating film 12 or 112 formed to the switching device substrate 10 to the transparent insulating substrate 1b of the color filter substrate 20. This width B is a gap of the seal portion according to a related art. Moreover, C indicates a gap of the region in which wiring is not formed in the switching device substrate 10 edge portion and D indicates the projecting length of the seal material to the terminal area 8a of the adjacent panel. Furthermore, E is the abovementioned projecting length of the seal material of a related art, F is the projecting width of the seal material in this embodiment and G is the projecting width of the seal material in a related art Note that F and G indicate the projecting width of the seal material when viewing the liquid crystal display panel from the top surface. In this case, each width A to G satisfies the following relationship.

A×D×F=B×E×G (1)

D×F=B/A×E×G (2)

If the application amount of the seal material is constant (volume is the same) and the gap A of the seal portion is enlarged, the projecting length D and the projecting width F of the seal will become small. This is effective as the value of the gap A of the projecting portion increases. In order to secure the gap A of the projecting portion, in this embodiment, the insulating film 12 of the terminal area 8a of the panel which is adjacent to the inlet portion is removed.

As in this embodiment, with the method to remove the insulating film 12, even if there is a displacement of the seal pattern (seal material), the pattern expands in the region having the insulating film 12 and the pattern becomes thin in the region with no insulating film 12. Therefore, even with a displacement of the seal pattern, necessary seal width for the inlet portion 5 can be easily secured.

In this embodiment, as shown in FIGS. 3A and 3B, by removing the insulating film 12 of the TFT substrate at the panel edge, the gap of the projecting portion can be the gap A. Thus the projecting length D and the projecting width F of the seal of the inlet portion 5 can be made small. The insulating film 12 can be formed by SiN or an organic layer and the insulating film 12 of the terminal area 8a of the panel adjacent to the inlet portion 5 of the target panel can be removed by pattern etching etc.

Next, the manufacturing method of the liquid crystal display panel according to this embodiment is explained. The switching device substrate 10 is manufactured by repeating pattern formation processes such as film formation, patterning by the photolithography and etching to one surface of the transparent insulating substrate 1a and forming the switching device 6, the pixel electrode 7, the terminal 8 and the transfer electrode 22. However, as mentioned above, the insulating film 12 by the side of the terminal 8 of the switching device substrate 10 is removed in an intermediate process. Moreover, the color filter substrate 20 is manufactured by forming the color filter 14 and the common electrode 13 to one surface of the transparent insulating substrate 1b in a similar way. As a light-shielding film (black matrix) material, a resin black matrix or a chromic oxide material, etc. can be used. Moreover, as described later, the light shielding film 15 may be removed in the terminal area adjacent to the inlet portion.

Furthermore, the field attachments of the liquid crystal panels are regularly arranged in parallel to the short and long sides of the substrate so that many liquid crystal panels 100 can be manufactured efficiently from a pair of the switching device substrate 10 and the color filter substrate 20.

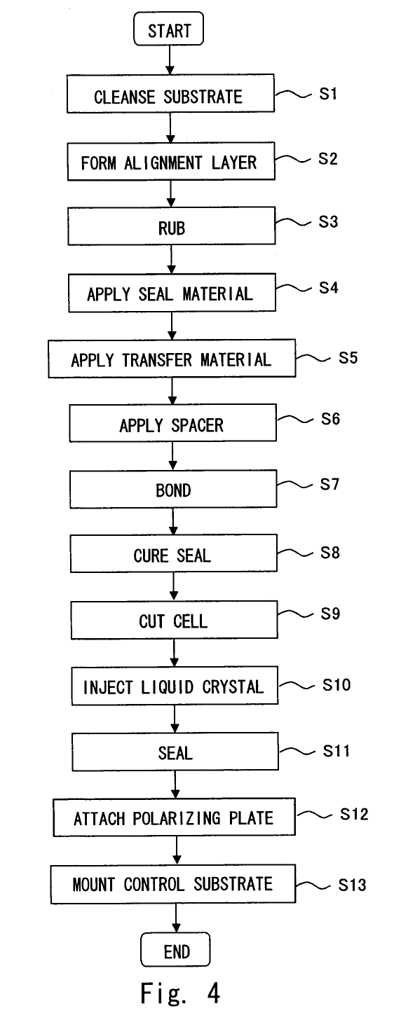

Then, an assembly process is explained with reference to the flowchart shown in FIG. 4. Firstly, in a substrate cleaning process, the switching device substrate 10 having the pixel electrode 7 formed therein is cleansed (Step S1). Next, in an alignment layer formation process, the alignment layer 16 is formed to one surface of the switching device substrate 10 (Step S2). In this process, the alignment layer 16 formed of an organic film is applied by printing method, for example, baked using a hot plate or the like and dried. Then, in a rubbing process, the alignment layer 16 is rubbed to align the alignment layer 16 (Step S3).

Moreover, as for the color filter substrate 20 having the common electrode formed therein, cleansing, formation of the alignment layer 17, and rubbing are performed in a similar way from Step S1 to S3.

Subsequently, in a seal application process, the seal material 4 is applied to one surface of the switching device substrate 10 or the color filter substrate 20 by a screen printing device (Step S4). For the seal material 4, for example heat hardening type resin such as epoxy adhesive and ultraviolet curing type resin can be used.

Next, in a transfer material application process, a transfer material is applied to one surface of the switching device substrate 10 or the color filter substrate 20 (Step S5). Then, in a spacer dispersion process, spacer is dispersed to one surface of the switching device substrate 10 or the color filter substrate 20 (Step S6). This process can be performed by dispersing spacer with wet or dry method, for example.

After that, in a bonding process, the switching device substrate 10 and the color filter substrate 20 are bonded together (Step S7). Then, in a seal curing process, the seal material 4 is cured completely while the switching device substrate 10 and the color filter substrate 20 are bonded together (Step S8). This process is performed by applying heat or irradiating with ultraviolet rays according to the material of the seal material 4. Next, in a cell cutting process, the substrates bonded together is decomposed into many individual cells (Step S9). Then, in a liquid crystal injection process, a liquid crystal is injected from a liquid crystal inlet to an individual cell (Step S10). This process is performed by vacuum injecting and filling with the liquid crystal 9 from the liquid crystal inlet. Furthermore, the liquid crystal inlet is sealed in a sealing process (Step S11). This process is performed by sealing with a light curing resin and irradiating with light.

Finally in a polarizing plate application process, the polarizing plates 18 and 19 are attached to the cell (Step S12). In a control substrate mounting process, the control substrate 24 is mounted (Step S13). The liquid crystal display panel 100 is completed according to these processes.

In the first embodiment, as the configuration to remove all the insulating film 12 of the terminal area 8a, only some layers may be removed among the multiple insulating films 12. Moreover, also in the terminal area 8a, the insulating film 12 at least near the panel edge portion 12 should just be removed. Especially, by removing only the portion not concerning the terminal area 8a, the terminal will not separate when removing the insulating film and similarly, the projecting portion (protrusion) of the seal material to the panel adjacent to the inlet portion 5 can be suppressed.

Moreover, in the above embodiment, it is explained that all of the insulating film 12 of the terminal area 8a region of the liquid crystal display panel adjacent to the inlet portion 5 is removed, however the insulating film 12 in a part of the region may be removed. Furthermore, by removing the light-shielding film 15 of the inlet portion 5, the projecting length D and the projecting width F of the seal may be made small.

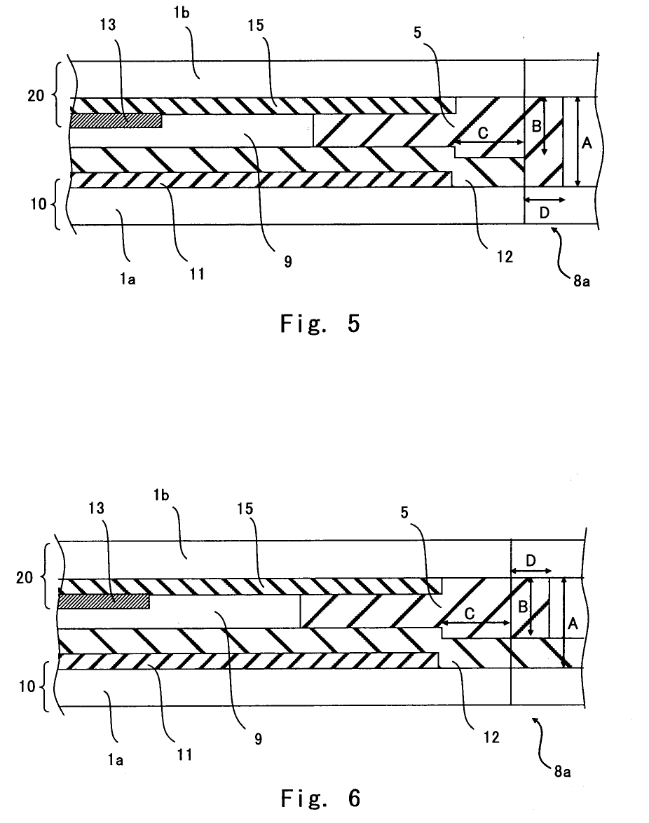

FIG. 5 shows a liquid crystal display panel according to the first modification of this embodiment. As shown in FIG. 5, by further removing the light-shielding film 15 formed to the color filter substrate 20 in the terminal area edge of the liquid crystal display panel adjacent to the inlet portion 5, the projecting length D and the projecting width F of the seal can be made further smaller.

FIG. 6 shows a liquid crystal display panel according to the second modification of this embodiment. As shown in FIG. 6, even without removing the insulating film 12 of the switching device substrate 10, by removing the light-shielding film 15 of the color filter substrate 20 near the inlet portion 5, which is in the panel edge, the projecting length D and the projecting width F of the seal can be made small.

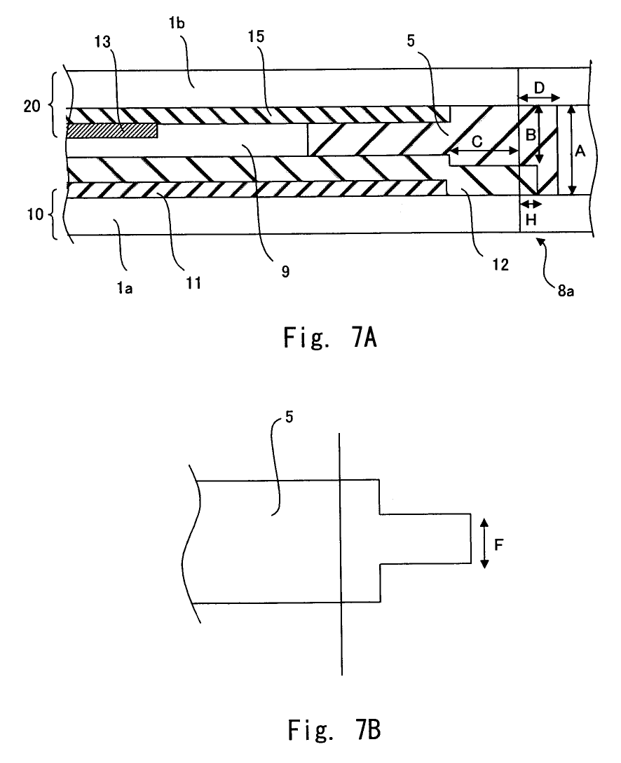

FIGS. 7A and 7B show a liquid crystal display panel and a plan view of an inlet portion according to the third modification of this embodiment. As shown in FIGS. 7A and 7B, the position to remove the insulating film 12 of the TFT substrate may be projected from the panel outline. By projecting the position to remove the insulating film 12 from the panel outline, the seal width can be increased for the remaining portion after cutting. The portions with large seal width and small seal width can be designed freely.

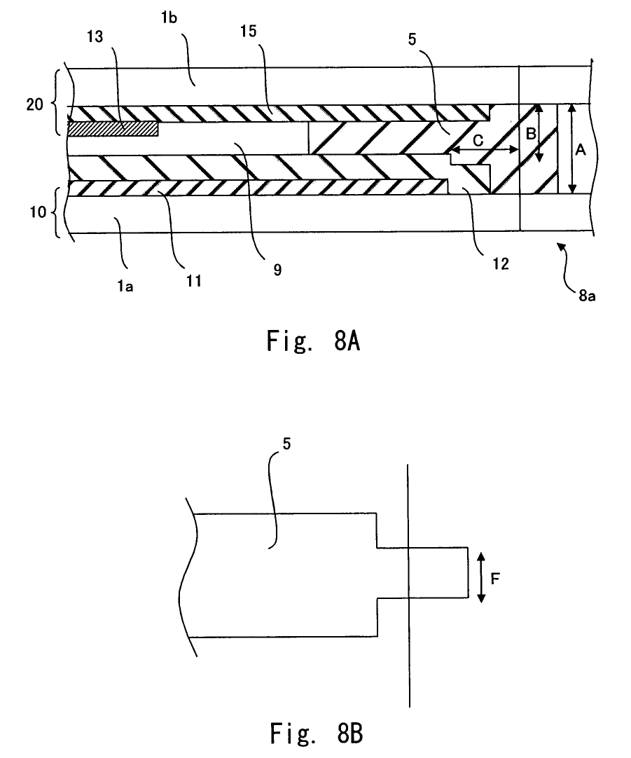

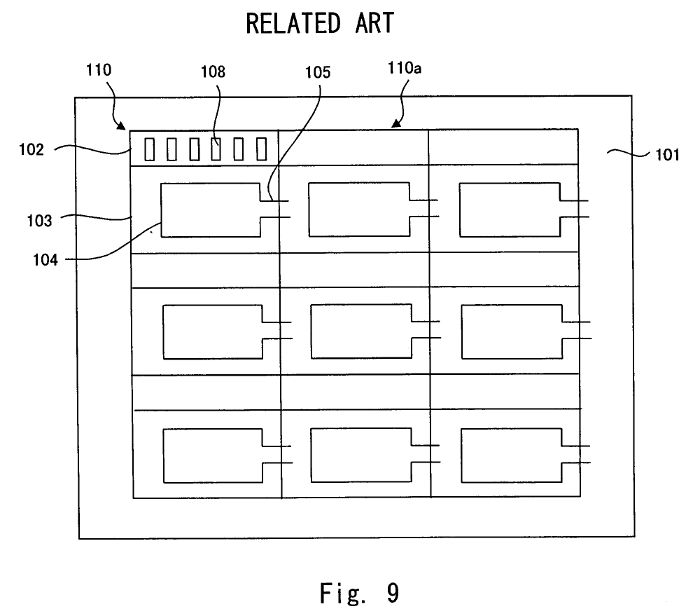

FIGS. 8A and 8B show a liquid crystal display panel and a plan view of an inlet portion according to the fourth modification of this embodiment. As shown in FIGS. 8A and 8B, near the panel edge, the portion to remove the insulating film 12 may be inside the panel edge. By making it inside, the projecting length D and the projecting width F of the inlet portion can further be made smaller.

As mentioned above, in this embodiment, by removing the insulating film 12 in the panel edge or a part or all of the light-shielding film 15, or removing a part or all of the insulating film 12 and the light-shielding film 15, the gap of the seal portion can be increased to reduce the projecting amount of the seal. Reducing the projecting amount of the seal facilitates cutting and also enables to reduce the terminal area. Moreover, in this embodiment, since the seal width can be controlled even if there is a displacement of the seal pattern, the design margin improves. This enables to manufacture a panel with many field attachments contributes to cost reduction.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A liquid crystal display panel comprising:
a first substrate comprising a first transparent insulating substrate, a plurality of scanning lines formed over the first transparent insulating substrate, a plurality of signal lines disposed in matrix to cross the scanning lines, a first insulating film for electrically insulating the scanning lines and the signal lines, a second insulating film for covering and protecting the signal lines, a switching device provided to correspond with each crossing part of the plurality of scanning lines and the plurality of signal lines and a pixel electrode electrically connected with the switching device;
a second substrate comprising a second transparent insulating substrate disposed to oppose the first transparent insulating substrate, a light-shielding layer and a coloring layer formed to a side of the first transparent insulating substrate over the second transparent insulating substrate; and
a seal material provided between the first substrate and the second substrate and also in a peripheral portion of a display region,
wherein at least a part of the first insulating film or the second insulating film of a terminal area adjacent to a liquid crystal inlet portion of the seal material of another liquid crystal display panel is removed, the another liquid crystal display panel being adjacent to the liquid crystal panel before cutting.

2. The liquid crystal display panel according to claim 1, wherein a part of the light-shielding layer in the liquid crystal inlet portion is removed for the second substrate.

3. The liquid crystal display panel according to claim 1, wherein at least a part of the first insulating film or the second insulating film of the liquid crystal inlet portion is removed for the first substrate.

4. The liquid crystal display panel according to claim 2, wherein at least a part of the first insulating film or the second insulating film of the liquid crystal inlet portion is removed for the first substrate.

5. A liquid crystal display panel comprising:
a first substrate comprising a first transparent insulating substrate, a plurality of scanning lines formed of a metal layer formed over the first transparent insulating substrate, a plurality of signal lines disposed in matrix to cross the scanning lines, a first insulating film for electrically insulating the scanning lines and the signal lines, a second insulating film for covering and protecting the signal line, a switching device provided to correspond with each crossing part of the plurality of scanning lines and the plurality of signal lines and a pixel electrode electrically connected with the switching device;
a second substrate comprising a second transparent insulating substrate disposed to oppose the first transparent insulating substrate, a light-shielding layer and a coloring layer formed to a side of the first transparent insulating substrate over the second transparent insulating substrate; and
a seal material provided between the first substrate and the second substrate and also in a peripheral portion of a display region,
wherein a part of the light-shielding layer in a liquid crystal inlet portion is removed for the second substrate.

6. The liquid crystal display panel according to claim 5, wherein at least a part of the first insulating film or the second insulating film of the liquid crystal inlet portion is removed for the first substrate.

7. A method of manufacturing a liquid crystal panel comprising:
forming switching devices over a first transparent insulating substrate;
forming a first insulating film for electrically insulating a scanning line and a signal line and a second insulating film for covering and protecting the signal line over the switching devices;
forming a pixel electrode provided to correspond with each crossing part of a plurality of the scanning lines and a plurality of the signal lines over the second insulating film; and
removing at least a part of the first insulating film or the second insulating film in a terminal area adjacent to a liquid crystal inlet portion of another liquid crystal display panel, the another liquid crystal panel being adjacent to the liquid crystal panel before cutting substrates.

8. A method of manufacturing a liquid crystal display panel comprising:
forming switching devices over a first transparent insulating substrate;
forming a first insulating film for electrically insulating a scanning line and a signal line and a second insulating film for covering and protecting the signal line over the switching devices;
forming a light-shielding layer and a coloring layer over a second transparent insulating substrate disposed to oppose the first transparent insulating substrate;
removing a part of the light-shielding layer over the second transparent insulating substrate in a liquid crystal inlet portion to form a second substrate; and
bonding the first substrate and the second substrate with a seal material therebetween.

9. The method according to claim 8, wherein in the formation of the first substrate, at least a part of the first insulating film or the second insulating film in a terminal area adjacent to a liquid crystal inlet portion of another liquid crystal display panel, the another liquid crystal display panel being adjacent before cutting substrates.

10. The method according to claim 8, wherein in the formation of the first substrate, at least a part of the first insulating film or the second insulating film of the liquid crystal inlet portion is removed.

11. The method according to claim 9, wherein in the formation of the first substrate, at least a part of the first insulating film or the second insulating film of the liquid crystal inlet portion is removed.
